(19) United States
(12) Patent Application Publication
(10) Pub. No.: US 2026/0367362 A1
(43) Pub. Date: Nov. 19, 2026

(54) OPTICAL SYSTEM AND IMAGING APPARATUS INCLUDING THE SAME

(71) Applicant: CANON KABUSHIKI KAISHA, Tokyo (JP)

(72) Inventor: TAKASHI OKADA, Saitama (JP)

(21) Appl. No.: 19/662,445

(22) Filed: Apr. 29, 2026

(30) Foreign Application Priority Data
May 7, 2025 (JP) 2025-077217

(51) Int. Cl. G02B 13/00; G02B 9/64

(52) U.S. Cl. CPC G02B 13/0045; G02B 9/64

(57) ABSTRACT

An optical system includes a front lens group having a negative refractive power as a whole, an aperture stop, and a rear lens group having a positive refractive power as a whole, wherein the front lens group includes a first lens, that is arranged closest to the object side and has a negative refractive power, wherein the rear lens group includes a final lens, that is arranged closest to the image side and has a negative refractive power, wherein the optical system includes three or more lenses that are arranged between the first lens and the final lens, wherein an image side lens surface of the first lens has a concave surface facing the image side, wherein an image side lens surface of the final lens has an inflection point and has a concave surface facing the image side, and wherein a predetermined inequality is satisfied.

### BACKGROUND

### Field of the Technology

The aspect of the embodiments relates to an optical system and an imaging apparatus including the same.

### Description of the Related Art

In recent years, imaging apparatuses such as cameras using imaging elements, cameras for smartphones, on-vehicle cameras, monitoring cameras, and the like are required to adopt optical systems that have excellent optical performance from the center to the periphery of the angle of view while being compact and lightweight.

United States Patent Publication No. 2019/0187442 describes an optical system configured with seven lenses including two negative lenses that are arranged consecutively in the optical axis direction.

### SUMMARY

An optical system as one aspect of the embodiments includes, in order from an object side to an image side, a front lens group, an aperture stop, and a rear lens group having a positive refractive power as a whole, wherein the front lens group includes a first lens, that is arranged closest to the object side and has a negative refractive power, the rear lens group includes a final lens, that is arranged closest to the image side and has a negative refractive power, the optical system includes four or more lenses that are arranged between the first lens and the final lens, an image side lens surface of the first lens has a concave surface facing the image side, an image side lens surface of the final lens has an inflection point and has a concave surface facing the image side, and the following inequality is satisfied: 0.1<LDW/|Y90_LR2|<4.0, where LDW is a distance on an optical axis from an object side lens surface of the first lens to the image side lens surface of the final lens, and Y90_LR2 is a height from a position, where a principal ray corresponding to a half angle of view of 90° is incident on the image side lens surface of the final lens, to the optical axis in the optical system.

Features of the disclosure will become apparent from the following description of embodiments with reference to the attached drawings. The following description of embodiments is described by way of example.

### BRIEF DESCRIPTION OF THE DRAWINGS

FIG. 1 is a cross-sectional view of an optical system according to a first example.

FIG. 2 is an aberration diagram of the optical system according to the first example.

FIG. 3 is a cross-sectional view of an optical system according to a second example.

FIG. 4 is an aberration diagram of the optical system according to the second example.

FIG. 5 is a cross-sectional view of an optical system according to a third example.

FIG. 6 is an aberration diagram of the optical system according to the third example.

FIG. 7 is a cross-sectional view of an optical system according to a fourth example.

FIG. 8 is an aberration diagram of the optical system according to the fourth example.

FIG. 9 illustrates an imaging apparatus that adopts the optical system according to the example.

### DESCRIPTION OF THE EMBODIMENTS

Embodiments according to the disclosure will be described in detail below with reference to the attached drawings. The same members are denoted by the same reference numerals throughout the drawings, and redundant description will be omitted.

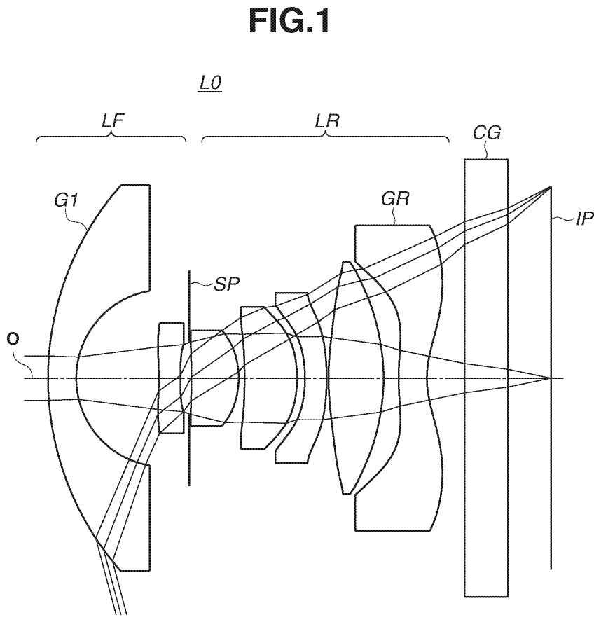

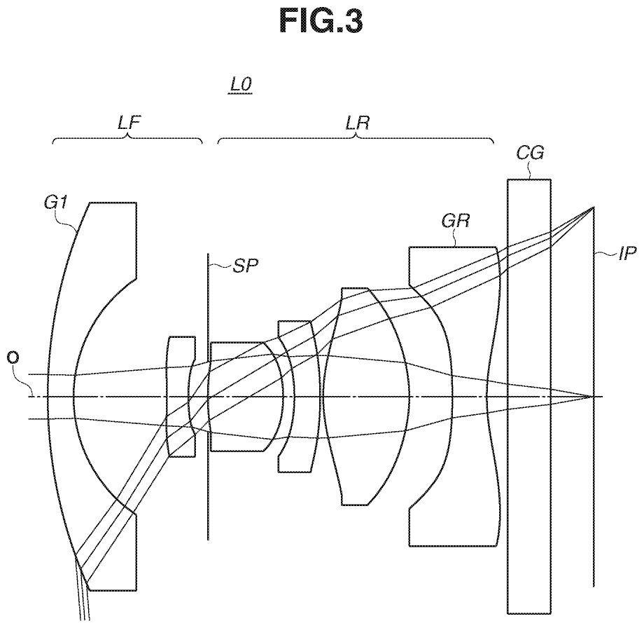

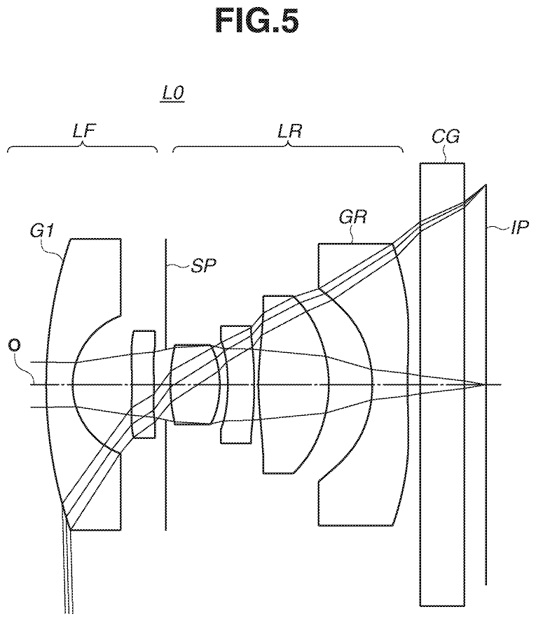

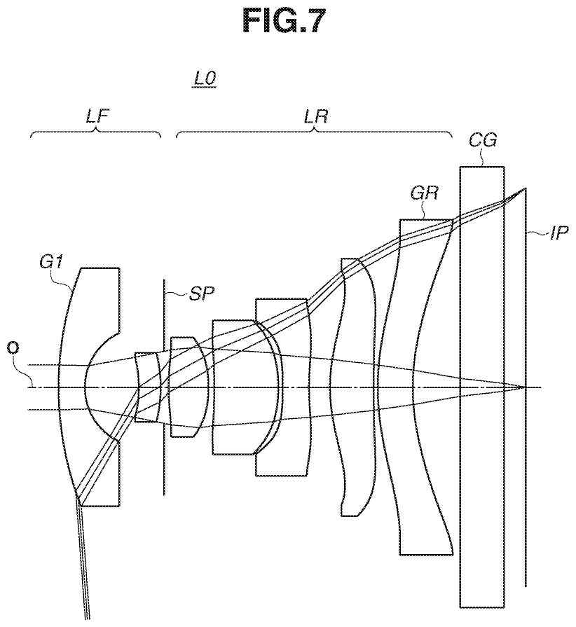

FIGS. 1, 3, 5, and 7 are cross-sectional views of an optical system LO according to first to fourth examples, respectively, when focused at infinity. The optical system LO according to each example is used in an imaging apparatus such as a digital still camera, a digital video camera, a monitoring camera, an on-vehicle camera, a smartphone, or the like.

In each cross-sectional view, the left side is an object side (front) and the right side is an image side (rear). An aperture stop SP determines (limits) light flux of a full aperture F-number (Fno). The optical system LO according to each example includes a plurality of lenses or optical elements. The optical system LO according to each example may include optical elements such as an aspherical lens, a Fresnel lens, a metalens, or a diffractive optical element, and may also include an optical element having substantially no refractive power, such as a cover glass.

In a case where the optical system LO according to each example is used in an imaging apparatus such as a camera for a mobile terminal, a video camera, a digital camera, or the like, an image plane IP corresponds to a solid-state imaging element (photoelectric conversion element) such as a charge coupled device (CCD) sensor, a complementary metal oxide semiconductor (CMOS) sensor, or the like. In a case where the optical system LO according to each example is used in an imaging apparatus of a silver-halide film camera, the image plane IP corresponds to a film plane.

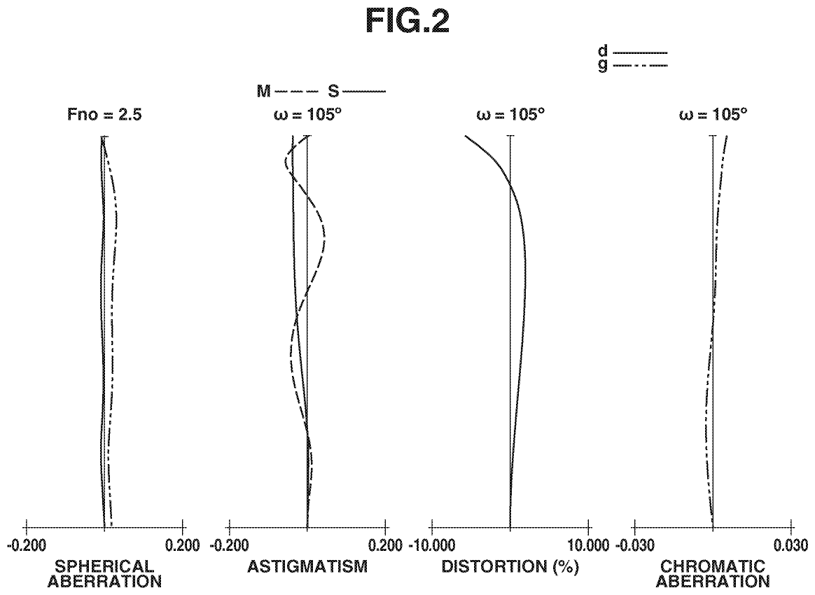

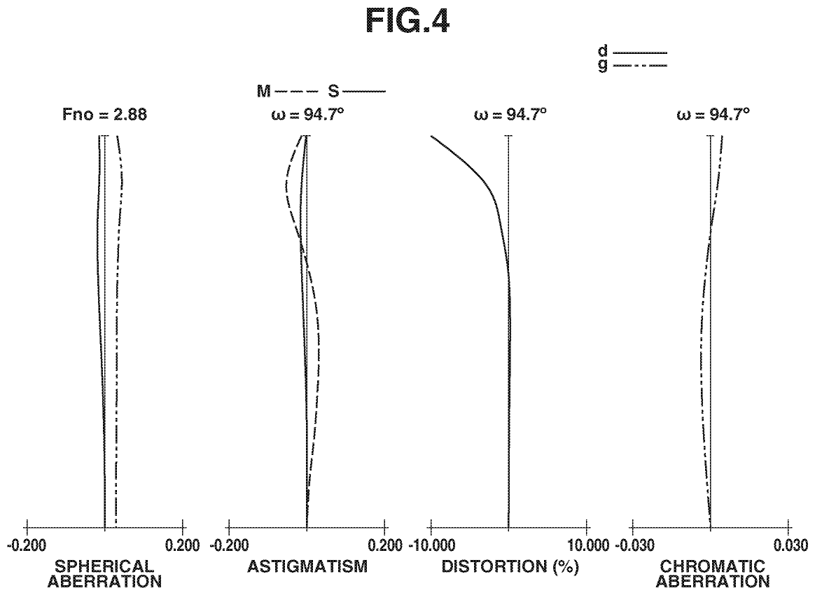

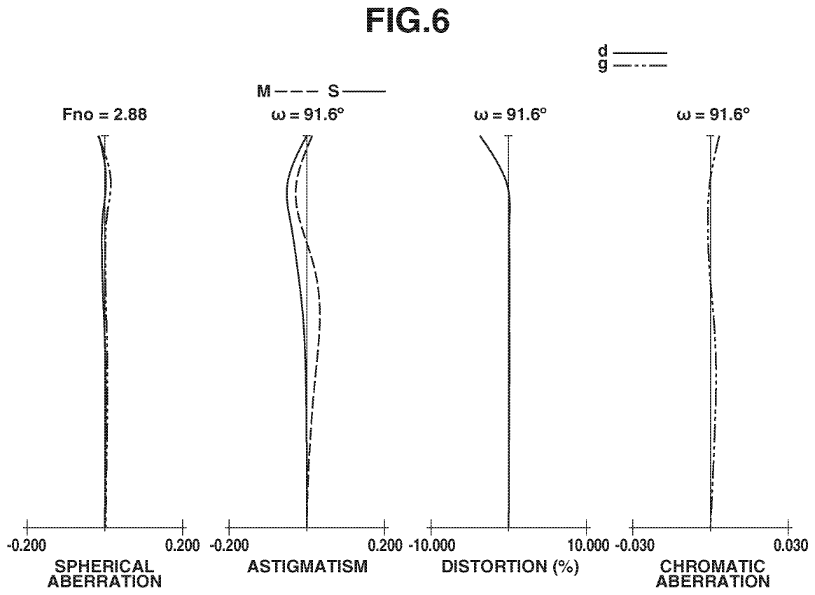

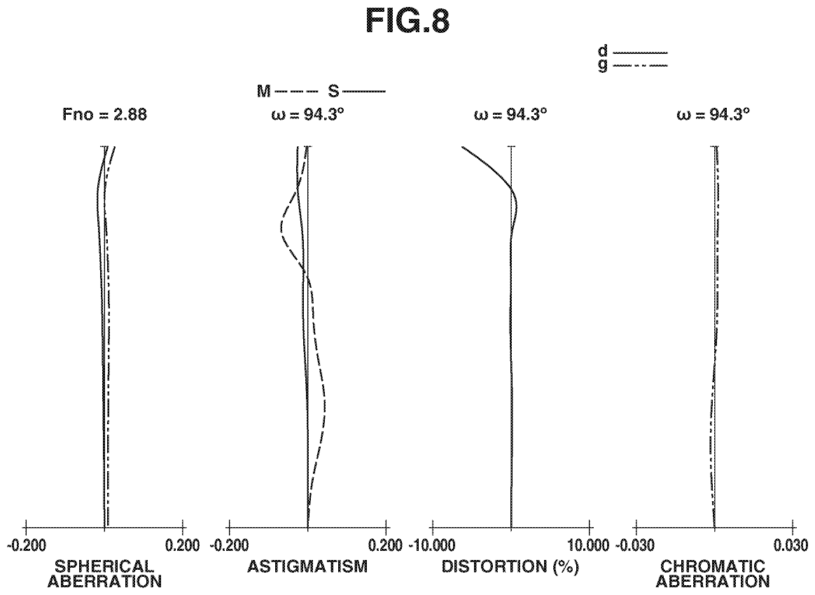

FIGS. 2, 4, 6, and 8 are aberration diagrams of the optical system LO according to the first to fourth examples, respectively, when focused at infinity.

In the spherical aberration diagram, Fno is an F-number, a solid line indicates an amount of spherical aberration for a d-line (wavelength 587.6 nm), and a double-dashed line indicates an amount of spherical aberration for a g-line (wavelength 435.8 nm). In the astigmatism diagram, a solid line S indicates a sagittal image plane, and a dashed line M indicates a meridional image plane. The distortion aberration diagram indicates an amount of distortion aberration for the d-line. The chromatic aberration diagram indicates chromatic aberration at the g-line. Further, ω is a half angle of view [°].

Next, a characteristic configuration of the optical system LO according to each example is described.

The optical system LO according to each example includes a front lens group LF, the aperture stop SP, and a rear lens group LR, which are arranged in this order from the object side to the image side. The front lens group LF and the rear lens group LR include a plurality of lenses. The front lens group LF has a negative refractive power as a whole, and the rear lens group LR has a positive refractive power as a whole. Since the front lens group LF arranged on the object side of the optical system LO has a negative refractive power, the optical system LO has a retrofocus type configuration, and thus a principal point of the optical system LO is located on the image side, and it is possible to secure a back focus. Further, the optical system LO can be reduced in size in a radial direction.

In the optical system LO according to each example, the front lens group LF includes a first lens G1 that is arranged closest to the object side and has a negative refractive power. The first lens G1 that is arranged closest to the object side in the optical system LO has a strong negative refractive power, so that the optical system LO can have a wide angle of view.

In the optical system LO according to each example, the rear lens group LR includes a final lens GR that is arranged closest to the image side and has a negative refractive power. The final lens GR that is arranged closest to the image side in the optical system LO has a negative refractive power, so that field curvature can be effectively corrected at a peripheral angle of view.

Next, configurations that the optical system LO according to each example satisfies are described.

In the optical system LO according to each example, in one embodiment, an object side lens surface of the first lens G1 is a convex surface facing the object side. Accordingly, it is possible to achieve a wide angle of view for the optical system LO. Further, in another embodiment, the first lens G1 has a meniscus shape with a convex surface facing the object side, namely an image side lens surface of the first lens G1 is a concave surface facing the image side.

In the optical system LO according to each example, in one embodiment, the object side lens surface of the first lens G1 is a spherical surface. Accordingly, it is possible to suppress an occurrence of distortion aberration or chromatic aberration of magnification.

In the optical system LO according to each example, in one embodiment, the first lens G1 is made of a glass material. In a wide view angle optical system, the object side lens surface of the first lens G1 has a large radius of curvature, and thus, in one embodiment, the first lens G1 is made of a glass material, thereby improving environmental resistance.

In the optical system LO according to each example, in one embodiment, an image side lens surface of the final lens GR includes an aspherical shape having an inflection point. In more detail, in another embodiment, the image side lens surface of the final lens GR has a concave surface facing the image side near the optical axis and a convex surface facing the image side in the periphery.

By having a concave shape on the image side paraxially, it is possible to arrange a principal point position on the image side. Further, by having a convex shape on the image side in the periphery, it is possible to reduce a deflection angle with respect to the lens surface. As a result, it is possible to arrange the final lens GR having a strong negative refractive power near the image plane while securing a back focus. In order to improve manufacturability of such an aspherical surface, in one embodiment, the final lens GR is made of a resin material.

An inflection point refers to a point at which, where x is an amount of displacement from a surface vertex in an optical axis direction, h is a height in a direction perpendicular to the optical axis, and x(h) is an aspherical shape, a value of second derivative of x(h), obtained by differentiating x(h) twice with respect to h, becomes zero, and the sign of the second derivative changes before and after that point. In other words, an inflection point refers to a point where a surface shape switches from a concave shape to a convex shape, or from a convex shape to a concave shape. The lens surface has the inflection point, so that a peripheral refractive power can be determined independently of a paraxial refractive power, which makes it easier to correct the field curvature. A position of the inflection point can be arranged at an arbitrary position radially outward from the optical axis as long as it is within an effective diameter of the lens, and particularly, in another embodiment, it is arranged in a peripheral portion.

In the optical system LO according to each example, in one embodiment, three or more lenses are included between the first lens G1 and the final lens GR. Accordingly, it is possible to effectively correct various aberrations.

Next, conditions satisfied by the optical system LO according to each example are described.

In one embodiment, the optical system LO according to each example satisfies one or more of following inequalities (1) to (20). In each inequality, various numerical values are described as follows.

A distance on the optical axis from the object side lens surface of the first lens G1 to the image side lens surface of the final lens GR is defined as LDW.

In the optical system LO, a height from a position where a principal ray of the off-axis light corresponding to an half angle of view of 90° is incident on the object side lens surface of the first lens G1 to the optical axis is defined as Y90_L11, and a height from a position where the principal ray is incident on the image side lens surface of the first lens G1 to the optical axis is defined as Y90_L12. Further, a height from a position where the principal ray of the off-axis light corresponding to the half angle of view of 90° is incident on the image side lens surface of the final lens GR to the optical axis is defined as Y90_LR2.

A distance on the optical axis from the image side lens surface of the first lens G1 to an object side lens surface of a second lens G2 is defined as DT12, and a sum of air gaps between adjacent lenses on the optical axis from the image side lens surface of the first lens G1 to the object side lens surface of the final lens GR is defined as EDT.

A maximum image height of the optical system LO is defined as imgH.

A distance on the optical axis from an exit pupil to the image plane IP in the optical system LO is defined as Tkd.

A focal length of the entire optical system LO is defined as f, a focal length of the first lens G1 is defined as f1, a focal length of a third lens G3 is defined as f3, a focal length of the final lens GR is defined as fR, and a combined focal length of all the lenses arranged on the image side of the aperture stop SP in the optical system LO is defined as fP.

A refractive index and an Abbe number of a material of the first lens G1 for the d-line are respectively defined as Nd1 and vd1.

In the first lens G1, the radius of curvature of the object side lens surface is defined as L1R1, and the radius of curvature of the image side lens surface is defined as L1R2.

A half angle of view corresponding to the maximum image height of the optical system LO is defined as ω [°].

The F-number of the optical system LO is defined as Fno.

0.1<LDW/|Y90_LR2|<4.0 (1)

2.8<LDW/DT12<7.0 (2)

0.3<DT12/ΣDT<0.8 (3)

0.5<|Y90_LR2|/imgH<0.9 (4)

−4.6<Tkd/|Y90_LR2|<−1.2 (5)

0.6<|Y90_L11|/|Y90_LR2|<2.1 (6)

−2.5<f1/f<−0.7 (7)

1.48<Nd1<2.10 (8)

30.0<vd1<85.0 (9)

1.3<|Y90_L11/|Y90_L12|<2.3 (10)

0.8<L1R1/DT12<7.5 (11)

1.3<(L1R1+L1R2)/(L1R1−L1R2)<10 (12)

−5.0<fR/f<−0.8 (13)

0.4<fR/f1<50 (14)

0.5<f3/f<2.0 (15)

0.8<fP/f<2.0 (16)

90<ω<135 (17)

1.8<Fno<3.0 (18)

The inequality (1) defines a relationship between a total optical length of the optical system LO and an effective range of an optical surface near the image plane. “Height” refers to a distance from an optical axis OA to an arbitrary point in a direction perpendicular to the optical axis OA.

If the upper limit of the inequality (1) is exceeded, the total optical length becomes too large relative to the effective range of the optical surface, which is undesirable as it increases a size of the optical system LO. Further, the effective diameter of the optical surface near the image plane becomes too small, which is undesirable as it increases an incident angle of light and causes color shading. If the lower limit of the inequality (1) is not reached, the effective range of the optical surface near the image plane becomes too large relative to the total optical length, which is undesirable as it reduces the refractive power of the first lens G1 and makes it difficult to achieve an imaging angle of view exceeding 180°.

The inequality (2) defines a relationship between the total optical length of the optical system LO and a distance between the first lens G1 and the second lens G2.

If the upper limit of the inequality (2) is exceeded, the overall lens length becomes too long, which is undesirable as it increases the size of the optical system LO. Further, the distance between the first lens G1 and the second lens G2 becomes too small, which is undesirable as it makes it difficult to provide the first lens G1 with a sufficient refractive power and makes it difficult to achieve a wide angle. If the lower limit of the inequality (2) is not reached, the distance between the first lens G1 and the second lens G2 becomes too large, which is undesirable as it increases a lens diameter of the first lens G1.

The inequality (3) defines a relationship between the sum of air gaps between adjacent lenses in the optical system LO and the distance between the first lens G1 and the second lens G2.

If the upper limit of the inequality (3) is exceeded, the distance between the first lens G1 and the second lens G2 becomes too large, which is undesirable as it increases the lens diameter of the first lens G1. If the lower limit of the inequality (3) is not reached, the distance between the first lens G1 and the second lens G2 becomes too small, which is undesirable as it makes it difficult to provide the first lens G1 with a sufficient refractive power and makes it difficult to achieve a wide angle.

The inequality (4) defines a relationship between the maximum image height of the optical system LO and the effective range of the optical surface near the image plane.

If the upper limit of the inequality (4) is exceeded, the incident angle of the off-axis light on the image plane becomes too small, which is undesirable as it increases the overall lens length and the size of the optical system LO in the optical axis direction. If the lower limit of the inequality (4) is not reached, the incident angle of the off-axis light on the image plane becomes too large, which is undesirable as it causes color shading.

The inequality (5) defines a relationship between the effective range of the optical surface near the image plane and an exit pupil position.

If the upper limit of the inequality (5) is exceeded, the exit pupil position becomes too close to the image plane, which is undesirable as it increases the incident angle of the off-axis light on the image plane and causes color shading. If the lower limit of the inequality (5) is not reached, the exit pupil position becomes too close to the object side, which is undesirable as it reduces the incident angle of the off-axis light on the image plane, resulting in an increase in the overall lens length and an increase in the size of the optical system LO in the optical axis direction.

The inequality (6) defines a relationship between the effective range of the optical surface near the image plane and the effective range of the first lens G1.

If the upper limit of the inequality (6) is exceeded, the effective range of the first lens G1 becomes too large, which is undesirable as it increases the lens diameter of the first lens G1 and the size of the optical system LO in the radial direction. If the lower limit of the inequality (6) is not reached, the effective range of the optical surface near the image plane becomes too large, which is undesirable as it reduces the incident angle of the off-axis light on the image plane, resulting in an increase in the overall lens length and an increase in the size of the optical system LO in the optical axis direction.

The inequality (7) defines a relationship between the focal length in the entire optical system LO and the focal length of the first lens G1.

If the upper limit of the inequality (7) is exceeded, the refractive power of the first lens G1 becomes too small, which is undesirable as it makes it difficult to secure the imaging angle of view exceeding 180°. If the lower limit of the inequality (7) is not reached, the refractive power of the first lens G1 becomes too large, which is undesirable as it makes it difficult to correct chromatic aberration of magnification and field curvature.

The inequality (8) defines an exemplary range for the refractive index of the material of the first lens G1 with respect to the d-line.

If the upper limit of the inequality (8) is exceeded, the refractive index of the first lens G1 becomes too large, which is undesirable as it makes it difficult to correct axial chromatic aberration. If the lower limit of the inequality (8) is not reached, the refractive index of the first lens G1 becomes too small, which is undesirable as it increases variations in aberrations such as spherical aberration.

In one embodiment, the upper limit of the inequality (8) is set to 2.07, 2.04, 2.01, 1.98, 1.95, 1.92, 1.89, 1.86, 1.83, 1.80, 1.77, 1.74, 1.71, 1.68, 1.65, 1.62, 1.59, or 1.56. Further, in another embodiment, the lower limit of the inequality (8) is set to 1.49, 1.50, 1.51, 1.52, or 1.53.

The inequality (9) defines an exemplary range for the Abbe number of the material of the first lens G1 with respect to the d-line. If the upper limit of the inequality (9) is exceeded, the Abbe number of the first lens G1 becomes too large, which is undesirable as it makes it difficult to correct chromatic aberration of magnification. If the lower limit of the inequality (9) is not reached, the Abbe number of the first lens G1 becomes too small, which is undesirable as it causes overcorrection of chromatic aberration of magnification.

In one embodiment, the upper limit of the inequality (9) is set to 85, 84, 83, 82, 81, 80, 79, 78, 77, 76, 75, 74, 73, 72, 71, 70, 69, 68, 67, 66, or 65. Further, in another embodiment, the lower limit of the inequality (9) is set to 36, 37, 38, 39, 40, 41, 42, 43, 44, 45, 46, 47, 48, 49, 50, 51, or 52.

The inequality (10) defines a relationship between the effective ranges of the image side surface and the object side surface of the first lens G1.

If the upper limit of the inequality (10) is exceeded, the refractive power of the first lens G1 becomes too large, which is undesirable as it makes it difficult to correct chromatic aberration of magnification and field curvature. If the lower limit of the inequality (10) is not reached, the refractive power of the first lens G1 becomes too small, which is undesirable as it increases the overall lens length and the size of the optical system LO in the optical axis direction.

The inequality (11) defines a relationship between the distance between the first lens G1 and the second lens G2 and the radius of curvature of the image side lens surface of the first lens G1.

If the upper limit of the inequality (11) is exceeded, the radius of curvature of the image side lens surface of the first lens G1 becomes too large, which is undesirable as it reduces the refractive power of the first lens G1, and increases the overall lens length and the size of the optical system LO in the optical axis direction. If the lower limit of the inequality (11) is not reached, the radius of curvature of the image side lens surface of the first lens G1 becomes too small, which is undesirable as it makes it difficult to correct chromatic aberration of magnification and field curvature.

The inequality (12) defines a shape factor of the first lens G1.

If the upper limit of the inequality (12) is exceeded, the refractive power of the first lens G1 becomes small, which makes it difficult to achieve a sufficiently wide angle. If the lower limit of the inequality (12) is not reached, the refractive power of the first lens G1 becomes too large, which is undesirable as it makes it difficult to correct chromatic aberration of magnification and field curvature.

The inequality (13) defines a relationship between the focal length in the entire optical system LO and the focal length of the final lens GR.

If the upper limit of the inequality (13) is exceeded, the refractive power of the final lens GR becomes too small, which is undesirable as it increases the total optical length and the size of the optical system LO in the optical axis direction. If the lower limit of the inequality (13) is not reached, the refractive power of the lens closest to the image plane becomes too large, which is undesirable as it makes it difficult to correct the field curvature.

The inequality (14) defines a relationship between the focal length of the first lens G1 and the focal length of the final lens GR.

If the upper limit of the inequality (14) is exceeded, the refractive power of the final lens GR becomes too small, which is undesirable as it increases the overall lens length and the size of the optical system LO in the optical axis direction. If the lower limit of the inequality (14) is not reached, the refractive power of the lens closest to the image plane becomes too large, which is undesirable as it makes it difficult to correct the field curvature.

The inequality (15) defines a relationship between the focal length in the entire optical system LO and the focal length of the third lens G3.

If the upper limit of the inequality (15) is exceeded, the refractive power of the third lens G3 becomes too small, which is undesirable as it increases the overall lens length and the size of the optical system LO in the optical axis direction. If the lower limit of the inequality (15) is not reached, the refractive power of the third lens G3 becomes too strong, which is undesirable as it makes it difficult to correct spherical aberration and coma aberration.

The inequality (16) defines a relationship between the focal length in the entire optical system LO and the combined focal length of the lenses arranged on the image side of the aperture stop SP.

If the upper limit of the inequality (16) is exceeded, a combined refractive power of the lenses arranged on the image side of the optical system LO becomes too small, which is undesirable as it increases the overall lens length and the size of the optical system LO in the optical axis direction. If the lower limit of the inequality (16) is not reached, the combined refractive power of the lenses arranged on the image side of the optical system LO becomes too large, which is undesirable as it makes it difficult to correct coma aberration.

The inequality (17) defines the half angle of view corresponding to the maximum image height of the optical system LO. Here, the maximum image height of the optical system LO refers to a distance from a position where a peripheral light amount is 10% to the optical axis on the image plane IP, if a light amount at a position on the optical axis is 100%.

If the upper limit of the inequality (17) is exceeded, it becomes difficult to correct distortion aberration, which is undesirable. If the lower limit of the inequality (17) is not reached, distortion aberration and field curvature aberration are overcorrected, which is undesirable.

The inequality (18) defines the F-number of the optical system LO.

If the upper limit of the inequality (18) is exceeded, sufficient brightness cannot be ensured, resulting in a longer shutter speed, which is undesirable as it makes it difficult to capture an image comfortably. If the lower limit of the inequality (18) is not reached, it becomes difficult to correct spherical aberration, which is undesirable.

In one embodiment, the numerical ranges of the inequalities (1) to (18) are set as specified in the following inequalities (1a) to (18a).

2.0<LDW/|Y90_LR2|<3.6 (1a)

3.5<LDW/DT12<6.8 (2a)

0.32<DT12/2DT<0.72 (3a)

0.55<|Y90_LR2|/imgH<0.85 (4a)

−3.0<Tkd/|Y90_LR2|<−1.25 (5a)

0.65<|Y90_L11/|Y90_LR2|<1.7 (6a)

−2.3<f1/f<−0.9 (7a)

1.48<Nd1<1.93 (8a)

35.0<vd1<82.0 (9a)

1.4<|Y90_L11/|Y90_L12|<2.1 (10a)

2.0<L1R1/DT12<7.5 (11a)

1.35<(L1R1+L1R2)/(L1R1−L1R2)<4.0 (12a)

−40<fR/f<−1.0 (13a)

0.5<fR/f1<40 (14a)

0.8<f3/f<1.8 (15a)

0.82<fP/f<1.5 (16a)

90<ω<115 (17a)

2.0<Fno<2.95 (18a)

In one embodiment, the numerical ranges of the inequalities (1) to (18) are set as specified in the numerical ranges of the following inequalities (1b) to (18b).

2.2<LDW/|Y90_LR2|<3.5 (1b)

4.3<LDW/DT12<6.6 (2b)

0.33<DT12/ΣDT<0.68 (3b)

0.58<|Y90_LR2|/imgH<0.8 (4b)

−2.5<Tkd/|Y90_LR2|<−1.3 (5b)

0.68<|Y90_L11/|Y90_LR2|<1.4 (6b)

−2.2<f1/f<−1.0 (7b)

1.48<Nd1<1.86 (8b)

40.0<vd1<78.0 (9b)

1.5<|Y90_L11/|Y90_L12|<1.9 (10b)

3.0<L1R1/DT12<7.5 (11b)

1.38< (L1R1+L1R2)/(L1R1−L1R2)<2.0 (12b)

−3.6<fR/f<−1.1 (13b)

0.6<fR/f1<3.6 (14b)

1.0<f3/f<1.6 (15b)

0.83<fP/f<1.00 (16b)

91<0<110 (17b)

2.4<Fno<2.9 (18b)

Next, detailed configurations according to the first to fourth examples are described. In the optical system LO according to each example, the description of the same configuration as the optical system LO according to the first example is omitted, and differences from the first example are mainly described.

### First Example

The optical system LO according to the first example includes the front lens group LF having a negative refractive power, the aperture stop SP, and the rear lens group LR, which are arranged in this order from the object side to the image side. The front lens group LF includes the first lens G1 having a negative refractive power and the second lens G2 having a negative refractive power. The rear lens group LR includes the third lens G3 having a positive refractive power, a fourth lens G4 having a positive refractive power, a fifth lens G5 having a negative refractive power, a sixth lens G6 having a positive refractive power, and a seventh lens G7 having a negative refractive power. The seventh lens G7 corresponds to the final lens GR. The second to seventh lenses each have aspherical surfaces on both the object side and the image side. The image side lens surface of the seventh lens G7 has an inflection point. Also, a cover glass CG is provided.

### Second Example

The optical system LO according to the second example includes the front lens group LF having a negative refractive power, the aperture stop SP, and the rear lens group LR, which are arranged in this order from the object side to the image side. The front lens group LF includes the first lens G1 having a negative refractive power and the second lens G2 having a negative refractive power. The rear lens group LR includes the third lens G3 having a positive refractive power, the fourth lens G4 having a negative refractive power, the fifth lens G5 having a positive refractive power, and the sixth lens G6 having a negative refractive power. The sixth lens G6 corresponds to the final lens GR. The second to sixth lenses each have aspherical surfaces on both the object side and the image side. The image side lens surface of the sixth lens G6 has an inflection point.

### Third Example

The optical system LO according to the third example includes the front lens group LF having a negative refractive power, the aperture stop SP, and the rear lens group LR, which are arranged in this order from the object side to the image side. The front lens group LF includes the first lens G1 having a negative refractive power and the second lens G2 having a positive refractive power. The rear lens group LR includes the third lens G3 having a positive refractive power, the fourth lens G4 having a negative refractive power, the fifth lens G5 having a positive refractive power, and the sixth lens G6 having a negative refractive power. The sixth lens G6 corresponds to the final lens GR. The second to sixth lenses each have aspherical surfaces on both the object side and the image side. The image side lens surface of the sixth lens G6 has an inflection point.

### Fourth Example

The optical system LO according to the fourth example includes the front lens group LF having a negative refractive power, the aperture stop SP, and the rear lens group LR, which are arranged in this order from the object side to the image side. The front lens group LF includes the first lens G1 having a negative refractive power and the second lens G2 having a negative refractive power. The rear lens group LR includes the third lens G3 having a positive refractive power, the fourth lens G4 having a positive refractive power, the fifth lens G5 having a negative refractive power, the sixth lens G6 having a positive refractive power, and the seventh lens G7 having a negative refractive power. The seventh lens G7 corresponds to the final lens GR. The second to seventh lenses each have aspherical surfaces on both the object side and the image side. The image side lens surface of the seventh lens G7 has an inflection point.

Numerical examples corresponding to the optical systems LO according to the first to fourth examples are described below, respectively. In each example, i represents the order in which the optical axis O passes through the surfaces, counted from the object side, ri represents a paraxial radius of curvature of the i-th optical surface (i-th surface), and di represents an axial distance along the optical axis O between the i-th surface and the (i+1)-th surface. Further, ndi and vdi are the refractive index and the Abbe number of a material of the i-th optical member with respect to the d-line, respectively. The aspherical shape is expressed by the following equation:

x=(h²/R)/[1+{1−(1+k)(h/R)²}^{1/2}]+A4×h⁴+A6×h⁶+A8×h⁸+A10×h¹⁰+A12×h¹²+A14×h¹⁴+A16×h¹⁶

where the X axis is the optical axis direction, the H axis is perpendicular to the optical axis, the direction of light travel is positive, R is a paraxial radius of curvature, k is a conic constant, and A4, A6, A8, A10, A12, A14, and A16 are aspherical coefficients. * denotes a surface having an aspherical shape.

### First Numerical Example

Unit mm
Surface data

| | | | | | Effective |
|---|---|---|---|---|---|
| Surface number | r | d | nd | νd | diameter |
| 1 | 6.6349 | 0.650 | 1.72916 | 54.09 | 8.82 |
| 2 | 2.0224 | 1.899 | 3.99 | | |
| 3* | −8.0686 | 0.500 | 1.53500 | 56.00 | 2.52 |
| 4* | 19.7252 | 0.202 | 1.54 | | |
| 5 (aperture) | ∞ | 0.050 | 1.63 | | |
| 6* | −22.6284 | 1.088 | 1.53500 | 56.00 | 1.66 |
| 7* | −2.0006 | 0.135 | 2.18 | | |
| 8* | −17.3332 | 1.209 | 1.53500 | 56.00 | 2.80 |
| 9* | −2.9227 | 0.183 | 3.25 | | |
| 10* | −3.1171 | 0.500 | 1.67070 | 19.30 | 3.34 |
| 11* | −5.4141 | 0.044 | 3.89 | | |
| 12* | 6.2314 | 1.267 | 1.53500 | 56.00 | 5.17 |
| 13* | −4.0659 | 0.346 | 5.30 | | |
| 14* | 5.5739 | 0.650 | 1.67070 | 19.30 | 5.34 |
| 15* | 2.0778 | 0.861 | 6.98 | | |
| 16 | ∞ | 1.000 | 1.51633 | 64.14 | 10.00 |
| 17 | ∞ | 1.000 | 10.00 | | |
| Image plane | ∞ | | | | |

Aspherical surface data

| | |
|---|---|
| 3rd surface | K = −5.04391e−01 A4 = 6.41650e−02 |
| | A6 = −5.08978e−03 A8 = −3.47286e−02 |
| | A10 = 6.27684e−02 A12 = −5.33518e−02 |
| | A14 = 2.22459e−02 A16 = −3.66652e−03 |
| 4th surface | K = −1.02993e+04 A4 = 2.59154e−01 |
| | A6 = −6.33575e−01 A8 = 2.54445e+00 |
| | A10 = −6.50040e+00 A12 = 1.03751e+01 |
| | A14 = −9.15209e+00 A16 = 3.46568e+00 |
| 6th surface | K = 0.00000e+00 A4 = −5.53759e−03 |
| | A6 = 3.10526e−02 A8 = −1.32517e−01 |
| | A10 = 1.32998e−01 |
| 7th surface | K = 0.00000e+00 A4 = −4.75522e−02 |
| | A6 = 2.00241e−02 A8 = −2.26297e−02 |
| | A10 = 7.99123e−03 A12 = 3.52841e−05 |
| 8th surface | K = 0.00000e+00 A4 = −3.41532e−02 |
| | A6 = 2.11472e−02 A8 = −1.12800e−02 |
| | A10 = 5.74532e−03 A12 = −9.72315e−04 |
| 9th surface | K = 0.00000e+00 A4 = −4.86436e−02 |
| | A6 = −1.54905e−02 A8 = 1.06154e−02 |
| | A10 = −1.21779e−03 |
| 10th surface | K = 0.00000e+00 A4 = −2.21883e−02 |
| | A6 = −2.84339e−02 A8 = 7.16534e−03 |
| | A10 = 3.31904e−03 A12 = −8.49577e−04 |
| 11th surface | K = 0.00000e+00 A4 = −3.27894e−03 |
| | A6 = −1.57415e−02 A8 = 6.26118e−03 |
| | A10 = −8.93667e−04 A12 = 8.02883e−05 |
| 12th surface | K = 0.00000e+00 A4 = −1.06835e−02 |
| | A6 = −1.09084e−03 A8 −6.64473e−04 |
| | A10 = −5.71650e−05 |
| 13th surface | K = 0.00000e+00 A4 = 2.32286e−02 |
| | A6 = −9.09615e−03 A8 = 1.57612e−03 |
| | A10 = −9.53140e−05 |
| 14th surface | K = −4.08016e+00 A4 = −4.87237e−02 |
| | A6 = 1.00938e−03 A8 = 3.09888e−04 |
| | A10 = −1.33526e−05 |
| 15th surface | K = −4.08744e+00 A4 = −3.40537e−02 |
| | A6 = 5.92115e−03 A8 = −6.67701e−04 |
| | A10 = 4.56917e−05 A12 = −1.70665e−06 |
| | A14 = 2.54405e−08 |

Various data

| | |
|---|---|
| Focal length | 2.535 |
| F-number | 2.500 |
| Half angle of view | 105.000 |
| Image height | 4.377 |
| Overall lens length | 8.723 |
| Total optical length | 11.584 |
| BF (in air) | 2.521 |
| Entrance pupil position | 2.038 |
| Exit pupil position | −5.075 |
| Front principal point position | 3.514 |
| Rear principal point position | −1.541 |

Single lens data

| Lens | Start surface | Focal length |
|---|---|---|
| G1 | 1 | −4.242 |
| G2 | 3 | −10.637 |
| G3 | 6 | 4.028 |
| G4 | 8 | 6.384 |
| G5 | 10 | −12.004 |
| G6 | 12 | 4.805 |
| G7 (GR) | 14 | −5.337 |

### Second Numerical Example

Unit mm
Surface data

| | | | | | Effective |
|---|---|---|---|---|---|
| Surface number | r | d | nd | νd | diameter |
| 1 | 10.7047 | 0.600 | 1.75500 | 52.32 | 8.94 |
| 2 | 3.2650 | 2.168 | 5.44 | | |
| 3* | −10.2617 | 0.500 | 1.53500 | 55.73 | 2.76 |
| 4* | 5.0420 | 0.453 | 1.74 | | |
| 5 (aperture) | ∞ | 0.000 | 1.60 | | |
| 6* | 5.1270 | 1.748 | 1.53500 | 55.73 | 1.65 |
| 7* | −2.7469 | 0.261 | 2.50 | | |
| 8* | −3.7496 | 0.600 | 1.67070 | 19.30 | 2.74 |
| 9* | −7.2235 | 0.070 | 3.48 | | |
| 10* | 3.5002 | 2.000 | 1.53500 | 55.73 | 4.59 |
| 11* | −3.2501 | 1.000 | 5.00 | | |
| 12* | −11.0389 | 0.800 | 1.67070 | 19.30 | 5.15 |
| 13* | 4.2248 | 0.487 | 6.88 | | |
| 14 | ∞ | 1.000 | 1.51633 | 64.14 | 10.00 |
| 15 | ∞ | 1.000 | 10.00 | | |
| Image plane | ∞ | | | | |

Aspherical surface data

| | |
|---|---|
| 3rd surface | K = 0.00000e+00 A4 = 6.80234e−02 |
| | A6 = −1.69204e−02 A8 = 1.81169e−03 |
| 4th surface | K = 0.00000e+00 A4 = 1.33911e−01 |
| | A6 = −7.25853e−03 A8 = 1.84761e−02 |
| 6th surface | K = 0.00000e+00 A4 = 1.22341e−02 |
| | A6 = −5.61517e−03 A8 = −5.03352e−03 |
| 7th surface | K = 0.00000e+00 A4 = −6.95284e−02 |
| | A6 = 8.70604e−03 A8 = −3.39864e−03 |
| 8th surface | K = 0.00000e+00 A4 = −2.86633e−02 |
| | A6 = −1.16360e−03 A8 = −5.90531e−05 |
| 9th surface | K = 0.00000e+00 A4 = 1.92810e−04 |
| | A6 = −3.63237e−03 A8 = 1.05751e−03 |
| 10th surface | K = 0.00000e+00 A4 = −1.94951e−02 |
| | A6 = 1.34643e−03 A8 = −1.03002e−04 |
| 11th surface | K = 0.00000e+00 A4 = 1.56875e−02 |
| | A6 = −3.17275e−03 A8 = 2.36193e−04 |
| 12th surface | K = 0.00000e+00 A4 = −1.02465e−02 |
| | A6 = −2.76150e−03 A8 = 3.00815e−04 |
| | A10 = −1.38387e−06 |
| 13th surface | K = 0.00000e+00 A4 = −1.93335e−02 |
| | A6 = 1.36205e−03 A8 = −6.58403e−05 |
| | A10 = 8.10044e−07 |

Various data

| | |
|---|---|
| Focal length | 2.943 |
| F-number | 2.884 |
| Half angle of view | 94.705 |
| Image height | 4.377 |
| Overall lens length | 10.199 |
| Total optical length | 12.687 |
| BF (in air) | 2.147 |
| Entrance pupil position | 2.433 |
| Exit pupil position | −4.769 |
| Front principal point position | 3.875 |
| Rear principal point position | −1.943 |

Single lens data

| Lens | Start surface | Focal length |
|---|---|---|
| G1 | 1 | −6.446 |
| G2 | 3 | −6.248 |
| G3 | 6 | 3.624 |
| G4 | 8 | −12.491 |
| G5 | 10 | 3.513 |
| G6 (GR) | 12 | −4.462 |

### Third Numerical Example

Unit mm
Surface data

| | | | | | Effective |
|---|---|---|---|---|---|
| Surface number | r | d | nd | νd | diameter |
| 1 | 10.0852 | 0.600 | 1.55032 | 75.50 | 6.58 |
| 2 | 1.6542 | 1.348 | 3.11 | | |
| 3* | −12.1711 | 0.500 | 1.53500 | 55.73 | 2.42 |
| 4* | −9.7093 | 0.276 | 1.73 | | |
| 5 (aperture) | ∞ | 0.100 | 1.59 | | |
| 6* | 4.3305 | 1.121 | 1.53500 | 55.73 | 1.68 |
| 7* | −2.3950 | 0.184 | 1.79 | | |
| 8* | −4.3128 | 0.600 | 1.67070 | 19.30 | 2.03 |
| 9* | −10.1256 | 0.097 | 2.65 | | |
| 10* | 5.7402 | 1.600 | 1.53500 | 55.73 | 3.30 |
| 11* | −2.7530 | 0.988 | 4.01 | | |
| 12* | −2.7220 | 0.800 | 1.67070 | 19.30 | 4.37 |
| 13* | 13.9595 | 0.290 | 6.37 | | |
| 14 | ∞ | 1.000 | 1.51633 | 64.14 | 10.00 |
| 15 | ∞ | 0.500 | 10.00 | | |
| Image plane | ∞ | | | | |

Aspherical surface data

| | |
|---|---|
| 3rd surface | K = 0.00000e+00 A4 = 4.24609e−02 |
| | A6 = 6.30409e−03 A8 = −2.26692e−03 |
| 4th surface | K = 0.00000e+00 A4 = 1.14405e−01 |
| | A6 = −1.03913e−02 A8 = 1.82247e−02 |
| 6th surface | K = 0.00000e+00 A4 = 4.12344e−02 |
| | A6 = −1.73681e−02 A8 = −1.77210e−02 |
| 7th surface | K = 0.00000e+00 A4 = −5.30156e−02 |
| | A6 = 4.57211e−03 A8 = −1.28127e−02 |
| 8th surface | K = 0.00000e+00 A4 = −3.67636e−02 |
| | A6 = −1.16360e−03 A8 = −5.90531e−05 |
| 9th surface | K = 0.00000e+00 A4 = −1.82289e−02 |
| | A6 = 8.36192e−03 A8 = 3.01559e−03 |
| 10th surface | K = 0.00000e+00 A4 = −3.23383e−02 |
| | A6 = 7.34747e−03 A8 = −7.09082e−04 |
| 11th surface | K = 0.00000e+00 A4 = 1.80513e−02 |
| | A6 = −6.21146e−03 A8 = 6.39886e−04 |
| 12th surface | K = 0.00000e+00 A4 = −1.98280e−03 |
| | A6 = −5.27436e−03 A8 = 9.60107e−04 |
| 13th surface | K = 0.00000e+00 A4 = −1.64635e−02 |
| | A6 = 1.47854e−03 A8 = −5.28513e−05 |

Various data

| | |
|---|---|
| Focal length | 2.940 |
| F-number | 2.884 |
| Half angle of view | 91.630 |
| Image height | 4.527 |
| Overall lens length | 8.215 |
| Total optical length | 10.005 |
| BF (in air) | 1.450 |
| Entrance pupil position | 1.712 |
| Exit pupil position | −3.686 |
| Front principal point position | 2.587 |
| Rear principal point position | −2.440 |

Single lens data

| Lens | Start surface | Focal length |
|---|---|---|
| G1 | 1 | −3.689 |
| G2 | 3 | 83.792 |
| G3 | 6 | 3.060 |
| G4 | 8 | −11.686 |
| G5 | 10 | 3.722 |
| G6 (GR) | 12 | −3.332 |

### Fourth Numerical Example

Unit mm
Surface data

| | | | | | Effective |
|---|---|---|---|---|---|
| Surface number | r | d | nd | νd | diameter |
| 1 | 7.3338 | 0.600 | 1.53775 | 74.70 | 5.41 |
| 2 | 1.3587 | 1.234 | 2.46 | | |
| 3* | −2.7628 | 0.500 | 1.53500 | 55.73 | 1.37 |
| 4* | −3.0637 | 0.080 | 1.57 | | |
| 5 (aperture) | ∞ | 0.100 | 1.64 | | |
| 6* | 4.6224 | 0.911 | 1.53500 | 55.73 | 1.70 |
| 7* | −3.0369 | 0.129 | 2.26 | | |
| 8* | 469.4218 | 1.469 | 1.53500 | 55.73 | 2.65 |
| 9* | −3.2756 | 0.101 | 3.04 | | |
| 10* | −10.8097 | 0.600 | 1.67070 | 19.30 | 3.02 |
| 11* | 5.3028 | 0.480 | 4.02 | | |
| 12* | 3.6906 | 1.000 | 1.53500 | 55.73 | 5.36 |
| 13* | 52.9720 | 0.091 | 5.84 | | |
| 14* | 5.5922 | 0.800 | 1.53500 | 55.73 | 6.87 |
| 15* | 4.8261 | (variable) | 7.76 | | |
| 16* | ∞ | 1.000 | 1.51633 | 64.14 | 10.00 |
| 17* | ∞ | (variable) | 10.00 | | |
| Image plane | ∞ | | | | |

Aspherical surface data

| | |
|---|---|
| 3rd surface | K = 0.00000e+00 A4 = −1.06327e−03 |
| | A6 = −6.99043e−03 A8 = 2.22940e−02 |
| 4th surface | K = 0.00000e+00 A4 = −9.59546e−03 |
| | A6 = 4.50615e−02 A8 = −2.08616e−03 |
| 6th surface | K = 0.00000e+00 A4 = −4.81840e−02 |
| | A6 = 1.11128e−02 A8 = −6.30172e−03 |
| 7th surface | K = 0.00000e+00 A4 = −1.21995e−01 |
| | A6 = 4.55735e−02 A8 = −8.89853e−03 |
| 8th surface | K = 0.00000e+00 A4 = −8.24781e−02 |
| | A6 = 5.37734e−02 A8 = −7.04667e−03 |
| 9th surface | K = 0.00000e+00 A4 = −4.29460e−02 |
| | A6 = −1.59633e−03 A8 = 1.62857e−03 |
| 10th surface | K = 0.00000e+00 A4 = −9.55471e−02 |
| | A6 = −1.16360e−03 A8 = −5.90531e−05 |
| 11th surface | K = 0.00000e+00 A4 = −5.70771e−02 |
| | A6 = 7.67320e−03 A8 = −7.04089e−05 |
| 12th surface | K = 0.00000e+00 A4 = −1.58127e−02 |
| | A6 = 5.46220e−05 A8 = −3.65912e−05 |
| 13th surface | K = 0.00000e+00 A4 = 5.71623e−03 |
| | A6 = −1.73572e−03 A8 = 3.85445e−05 |
| 14th surface | K = 0.00000e+00 A4 = −4.81510e−03 |
| 15th surface | K = 0.00000e+00 A4 = −7.01524e−03 |
| | A6 = 5.07177e−04 A8 = −2.29746e−05 |

Various data

| | |
|---|---|
| Focal length | 2.934 |
| F-number | 2.884 |
| Half angle of view | 94.337 |
| Image height | 4.527 |
| Overall lens length | 8.094 |
| Total optical length | 10.678 |
| BF (in air) | 2.243 |
| Entrance pupil position | 1.528 |
| Exit pupil position | −6.107 |
| Front principal point position | 3.159 |
| Rear principal point position | −2.434 |

Single lens data

| Lens | Start surface | Focal length |
|---|---|---|
| G1 | 1 | −3.214 |
| G2 | 3 | −124.965 |
| G3 | 6 | 3.574 |
| G4 | 8 | 6.087 |
| G5 | 10 | −5.226 |
| G6 | 12 | 7.363 |
| G7 (GR) | 14 | −103.529 |

The various numerical values and the numerical values of the inequalities (1) to (18) in each numerical example are indicated in the following Tables 1 and 2.

TABLE 1

| | First | Second | Third | Fourth |
|---|---|---|---|---|
| | example | example | example | example |
| LDW | 8.723 | 10.199 | 8.215 | 8.094 |
| Y90_L11 | −3.390 | −3.826 | −2.917 | −2.419 |
| Y90_L12 | −1.830 | −2.468 | −1.452 | −1.146 |
| Y90_LR1 | 2.022 | 2.240 | 2.039 | 3.220 |
| Y90_LR2 | 2.562 | 2.973 | 3.021 | 3.553 |
| imgH | 4.377 | 4.377 | 4.528 | 4.528 |
| tkd | −6.068 | −5.769 | −4.186 | −6.607 |
| f1 | −4.242 | −6.446 | −3.689 | −3.214 |
| f2 | −10.637 | −6.248 | 83.792 | −124.965 |
| f3 | 4.028 | 3.624 | 3.060 | 3.574 |
| fR | −5.337 | −4.462 | −3.332 | −103.529 |
| fP | 2.481 | 2.452 | 2.504 | 2.835 |
| f | 2.535 | 2.943 | 2.940 | 2.934 |
| DT12 | 1.899 | 2.168 | 1.348 | 1.234 |
| ΣDT | 2.859 | 3.951 | 2.993 | 3.683 |
| L1R1 | 6.635 | 10.705 | 10.085 | 7.334 |
| L1R2 | 2.022 | 3.265 | 1.654 | 1.359 |
| Nd1 | 1.7292 | 1.7550 | 1.5503 | 1.5378 |
| νd1 | 54.09 | 52.32 | 75.50 | 74.70 |
| ω | 105.000 | 94.705 | 91.630 | 94.337 |
| Fno | 2.500 | 2.884 | 2.884 | 2.884 |

TABLE 2

| | First | Second | Third | Fourth |
|---|---|---|---|---|
| | example | example | example | example |
| Inequality (1) | 3.405 | 3.430 | 2.719 | 2.278 |
| Inequality (2) | 4.593 | 4.705 | 6.093 | 6.561 |
| Inequality (3) | 0.664 | 0.549 | 0.450 | 0.335 |
| Inequality (4) | 0.585 | 0.679 | 0.667 | 0.785 |
| Inequality (5) | −2.369 | −1.940 | −1.386 | −1.859 |
| Inequality (6) | 1.323 | 1.287 | 0.966 | 0.681 |
| Inequality (7) | −1.674 | −2.190 | −1.255 | −1.095 |
| Inequality (8) | 1.7292 | 1.7550 | 1.5503 | 1.5378 |
| Inequality (9) | 54.09 | 52.32 | 75.50 | 74.70 |
| Inequality (10) | 1.852 | 1.550 | 2.009 | 2.111 |
| Inequality (11) | 3.494 | 4.938 | 7.480 | 5.945 |
| Inequality (12) | 1.877 | 1.878 | 1.392 | 1.455 |
| Inequality (13) | −2.106 | −1.516 | −1.133 | −35.283 |
| Inequality (14) | 1.258 | 0.692 | 0.903 | 32.210 |
| Inequality (15) | 1.589 | 1.231 | 1.041 | 1.218 |
| Inequality (16) | 0.979 | 0.833 | 0.852 | 0.966 |
| Inequality (17) | 105.00 | 94.70 | 91.63 | 94.34 |
| Inequality (18) | 2.500 | 2.884 | 2.884 | 2.884 |
| Inequality (19) | −0.238 | −0.471 | 0.035 | −0.023 |

### [Imaging Apparatus]

Next, an imaging apparatus that adopts the optical system LO according to each example as an imaging optical system is described.

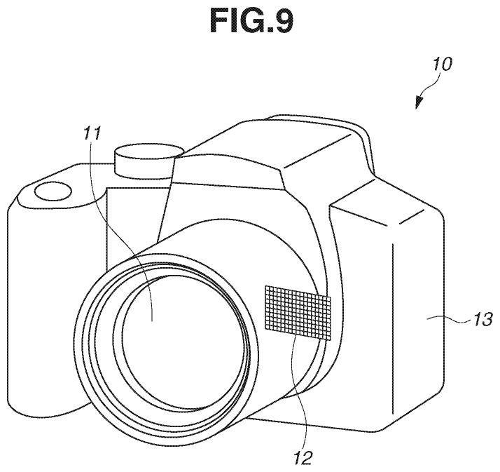

FIG. 9 is a schematic diagram of an imaging apparatus 10 provided with the optical system LO according to each example. The imaging apparatus 10 includes a camera body 13, an optical system 11 that is similar to any one of the optical systems LO described in the first to fourth examples above, and a light receiving element 12 that photoelectrically converts an image formed by the optical system 11.

The light receiving element 12 may be an imaging element such as a CCD or CMOS sensor. At this time, various aberrations such as distortion aberration and chromatic aberration of an image acquired by the light receiving element 12 are corrected using, for example, an electrical method, so that it is possible to improve quality of an output image.

The optical system LO according to each example can be applied not only to a digital still camera illustrated in FIG. 9, but also to various optical devices such as a digital video camera, a silver-halide film camera, and the like.

A camera may be either an integrated lens type or an interchangeable lens type.

While the disclosure of the specification has been described above with reference to embodiments and examples, it is to be understood that the disclosure of the specification is not limited to these embodiments and examples, and various combinations, modifications, and changes can be made within the scope of the gist of the disclosure.

This application claims the benefit of Japanese Patent Application No. 2025-077217, filed May 7, 2025, which is hereby incorporated by reference herein in its entirety.

What is claimed is:

1. An optical system comprising, in order from an object side to an image side, a front lens group that includes one or more lenses and has a negative refractive power as a whole, an aperture stop, and a rear lens group that includes one or more lenses and has a positive refractive power as a whole,
wherein the front lens group includes a first lens, that is arranged closest to the object side and has a negative refractive power,
wherein the rear lens group includes a final lens, that is arranged closest to the image side and has a negative refractive power,
wherein the optical system includes three or more lenses that are arranged between the first lens and the final lens,
wherein an image side lens surface of the first lens has a concave surface facing the image side,
wherein an image side lens surface of the final lens has an inflection point and has a concave surface facing the image side, and
wherein the following inequality is satisfied:
0.1<LDW/|Y90_LR2|<4.0
where LDW is a distance on an optical axis from an object side lens surface of the first lens to the image side lens surface of the final lens, and Y90_LR2 is a height from a position, where a principal ray corresponding to a half angle of view of 90° is incident on the image side lens surface of the final lens, to the optical axis in the optical system.

2. The optical system according to claim 1,
wherein the front lens group includes a second lens that is arranged adjacent to the image side of the first lens, and
wherein the following inequality is satisfied:
2.8<LDW/DT12<7.0
where DT12 is a distance on the optical axis from the image side lens surface of the first lens to an object side lens surface of the second lens.

3. The optical system according to claim 1,
wherein the front lens group includes a second lens that is arranged adjacent to the image side of the first lens, and
wherein the following inequality is satisfied:
0.3<DT12/2DT<0.8
where DT12 is a distance on the optical axis from the image side lens surface of the first lens to an object side lens surface of the second lens, and ΣDT is a sum of air gaps on the optical axis from the image side lens surface of the first lens to an object side lens surface of the final lens.

4. The optical system according to claim 1, wherein the front lens group includes the first lens and a second lens that is arranged adjacent to the image side of the first lens.

5. The optical system according to claim 1, wherein the following inequality is satisfied:
0.5<|Y90_LR2|/imgH<0.9
where imgH is a maximum image height of the optical system.

6. The optical system according to claim 1, wherein the following inequality is satisfied:
−4.6<Tkd/|Y90_LR2|<−1.2
where Tkd is a distance on the optical axis from an exit pupil to an image plane in the optical system.

7. The optical system according to claim 1, wherein the following inequality is satisfied:
0.6<|Y90_L11|/|Y90_LR2|<2.1
where Y90 L11 is a height from a position where a principal ray corresponding to a half angle of view of 90° is incident on the object side lens surface of the first lens to the optical axis in the optical system.

8. The optical system according to claim 1, wherein the following inequality is satisfied:
−2.5<f1/f<−0.7
where f1 is a focal length of the first lens, and f is a focal length of the entire optical system.

9. The optical system according to claim 1, wherein the first lens is made of a glass material.

10. The optical system according to claim 1, wherein the following inequalities are satisfied:
1.48<Nd1<2.10; and
30<vd1<85
where Nd1 is a refractive index and vd1 is an Abbe number of a material of the first lens with respect to a d-line.

11. The optical system according to claim 1, wherein the following inequality is satisfied:
1.3<|Y90_L11/|Y90_L12|<2.3
where Y90_L11 is a height from a position where a principal ray corresponding to a half angle of view of 90° is incident on the object side lens surface of the first lens to the optical axis, and Y90_L12 is a height from a position where the principal ray is incident on the image side lens surface of the first lens to the optical axis in the optical system.

12. The optical system according to claim 1, wherein the object side lens surface of the first lens has a convex surface facing the object side.

13. The optical system according to claim 1,
wherein the front lens group includes a second lens that is arranged adjacent to the image side of the first lens, and
wherein the following inequality is satisfied:
0.8<L1R1/DT12<7.5
where L1R1 is a radius of curvature of the object side lens surface of the first lens, and DT12 is a distance on the optical axis from the image side lens surface of the first lens to an object side lens surface of the second lens.

14. The optical system according to claim 1, wherein the object side lens surface of the first lens is a spherical surface.

15. The optical system according to claim 1, wherein the following inequality is satisfied:
1.3<(L1R1+L1R2)/(L1R1−L1R2)<10.0
where L1R1 is a radius of curvature of the object side lens surface of the first lens, and L1R2 is a radius of curvature of the image side lens surface of the first lens.

16. The optical system according to claim 1, wherein the following inequality is satisfied:
−5.0<fR/f<−0.8
where fR is a focal length of the final lens, and f is a focal length of the entire optical system.

17. The optical system according to claim 1, wherein the following inequality is satisfied:
0.4<fR/f1<5.0
where fR is a focal length of the final lens, and f1 is a focal length of the first lens.

18. The optical system according to claim 1,
wherein the optical system includes a third lens that is arranged third in the optical system counted in order from the object side and has a positive refractive power, and
wherein the following inequality is satisfied:
0.5<f3/f<2.0
where f3 is a focal length of the third lens, and fis a focal length of the entire optical system.

19. The optical system according to claim 1, wherein the following inequality is satisfied:
0.8<fP/f<2.0
where fP is a combined focal length of all lenses arranged on the image side of the aperture stop, and f is a focal length of the entire optical system.

20. An imaging apparatus comprising an optical system and an imaging element configured to receive light of an image formed by the optical system,
wherein the optical system includes, in order from an object side to an image side, a front lens group that includes one or more lenses and has a negative refractive power as a whole, an aperture stop, and a rear lens group that includes one or more lenses and has a positive refractive power as a whole,
wherein the front lens group includes a first lens, that is arranged closest to the object side and has a negative refractive power,
wherein the rear lens group includes a final lens, that is arranged closest to the image side and has a negative refractive power,
wherein the optical system includes three or more lenses that are arranged between the first lens and the final lens,
wherein an image side lens surface of the first lens has a concave surface facing the image side,
wherein an image side lens surface of the final lens has an inflection point and has a concave surface facing the image side, and
wherein the following inequality is satisfied:
0.1<LDW/|Y90_LR2|<4.0
where LDW is a distance on an optical axis from an object side lens surface of the first lens to the image side lens surface of the final lens, and Y90_LR2 is a height from a position, where a principal ray corresponding to a half angle of view of 90° is incident on the image side lens surface of the final lens, to the optical axis in the optical system.
